(19) United States
(12) Patent Application Publication
(10) Pub. No.: US 2025/0355753 A1
(43) Pub. Date: Nov. 20, 2025

(54) ESTIMATION SYSTEM, INFORMATION PROCESSING APPARATUS, AND ESTIMATION METHOD

(71) Applicant: Fujitsu Limited, Kawasaki-shi (JP)

(72) Inventor: Tatsuya KIKUZUKI, Kawasaki (JP)

(73) Assignee: Fujitsu Limited, Kawasaki-shi (JP)

(21) Appl. No.: 19/210,800

(22) Filed: May 16, 2025

(30) Foreign Application Priority Data
May 20, 2024 (JP) 2024-081964

(51) Int. Cl. G06F 11/07; G06F 16/353

(52) U.S. Cl. CPC G06F 11/079; G06F 11/0769; G06F 16/353

(57) ABSTRACT

An estimation system includes, a memory having a machine learning model and, a processor coupled to the memory and configured to, analyze a log related to a failure to determine a failure classification of a failure content, cause the machine learning model to extract, from a predetermined technical document, a corresponding sentence corresponding to the determined failure classification, cause the machine learning model to infer a first failure cause based on the corresponding sentence extracted by the machine learning model, and output the first failure cause.

### CROSS-REFERENCE TO RELATED APPLICATIONS

This application is based upon and claims the benefit of priority of the prior Japanese Patent Application No. 2024-081964, filed on May 20, 2024, the entire contents of which are incorporated herein by reference.

### FIELD

The embodiments discussed herein are related to an estimation system, an information processing apparatus, and an estimation method.

### BACKGROUND

For stable operation of an IT (Internet Technology) system and a network, a failure cause analysis technology capable of speeding up failure recovery is important. In a large-scale network or the like, it is important to perform both failure location identification for identifying a failure occurring device and failure cause analysis for identifying a specific cause leading to countermeasures.

In recent years, a configuration of an information processing system becomes complicated due to virtualization and multi-vendor support, and failure causes are diversified. For example, a network to which a multi-vendor remote unit (RU) and a distributed unit (DU) are connected is considered. In a case where a failure occurs in such a network, a hardware fault, a hardware compatibility defect, a software bug, a software compatibility defect, various setting errors, and the like are considered as failure causes. Due to such diversification of failure causes, failure cause analysis involves isolating and analyzing the various failure causes.

Conventionally, a rule-based analysis technology or a failure-case-based analysis technology has been often used in failure cause analysis. The rule-based analysis technology is a technology for classifying failures using an artificial intelligence (AI) technology such as an analysis algorithm or a large-scale language model in accordance with rules defined by experts in advance. In addition, the failure-case-based analysis technology is a technology that causes AI, a large language model (LLM), or the like to learn a log or a document of a failure case that has occurred in the past and infers a failure that has occurred currently.

As a technology of failure cause analysis using AI, for example, a cause estimation system has been proposed in which an error content at the time of failure is received as text information, and a failure cause is inferred using a feature amount created on the basis of information at the time of failure and success.
Patent Document 1: Japanese Laid-open Patent Publication No. 2021-196730

However, in the conventional failure cause analysis technology, the failure classification indicating the overall outline of failures can be analyzed, but the specific failure cause analysis leading to the countermeasure is limited to a limited range. The analysis of the failure classification is, for example, analysis up to the overall outline of failures such as a hardware fault, a software bug, a setting error of an RU, or a setting error of a DU. On the other hand, the analysis of the failure cause is, for example, analysis performed up to identification of a specific cause that leads to countermeasures such as lack of compatibility of cables and mismatch of IDs (identifiers).

For example, in a rule-based analysis technology, as for a specific failure cause, an analyzable range is limited to a failure cause predefined as a rule. In addition, in the failure-case-based analysis technology, the analyzable range is limited to the similar cases to the failures that have occurred in the past. Therefore, it is difficult to perform estimation with high accuracy in failure cause analysis.

In addition, a technology of inferring a failure cause using a feature amount based on information at the time of failure and success is also a failure-case-based analysis method, and the analyzable range is limited to the similar cases to the failures that have occurred in the past, thereby causing a difficulty in performing estimation with high accuracy in failure cause analysis.

### SUMMARY

According to an aspect of an embodiment, a estimation system includes, a memory having a machine learning model and, a processor coupled to the memory and configured to, analyze a log related to a failure to determine a failure classification of a failure content, cause the machine learning model to extract, from a predetermined technical document, a corresponding sentence corresponding to the determined failure classification, cause the machine learning model to infer a first failure cause based on the corresponding sentence extracted by the machine learning model, and output the first failure cause.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an estimation system according to a first embodiment;

FIG. 2 is a diagram illustrating an example of a failure classification logic tree for an RU-DU interoperability test;

FIG. 3 is a diagram illustrating an example of a failure classification logic tree created using an LLM;

FIG. 4 is a diagram illustrating another example of the failure classification logic tree created using an LLM;

FIG. 5 is a diagram illustrating an example of an occurrence probability acquisition prompt;

FIG. 6 is a diagram illustrating an example of a document extraction prompt;

FIG. 7 is a diagram illustrating another example of the document extraction prompt;

FIG. 8 is a diagram illustrating an example of a failure cause analysis prompt;

FIG. 9 is a flowchart of failure cause analysis processing by the estimation system according to the first embodiment;

FIG. 10 is a diagram illustrating comparison of estimation results between a case of simple LLM replacement and a case of using the estimation system according to the first embodiment;

FIG. 11 is a block diagram of an estimation system according to a second embodiment;

FIG. 12 is a flowchart of failure cause analysis processing by the estimation system according to the second embodiment;

FIG. 13 is a block diagram of an estimation system according to a third embodiment;

FIG. 14 is a diagram illustrating an example of a cause analysis prompt;

FIG. 15 is a flowchart of failure cause analysis processing by the estimation system according to the third embodiment;

FIG. 16 is a block diagram of an estimation system according to a fourth embodiment;

FIG. 17 is a block diagram of an estimation system according to a fifth embodiment;

FIG. 18 is a block diagram of an estimation system according to a sixth embodiment; and

FIG. 19 is a diagram illustrating an example of a hardware configuration of the estimation system.

### DESCRIPTION OF EMBODIMENTS

Preferred embodiments of the present invention will be explained with reference to accompanying drawings. Note that the estimation system, the information processing apparatus, and the estimation method disclosed in the present application are not limited by the following embodiments.

### (a) First Embodiment

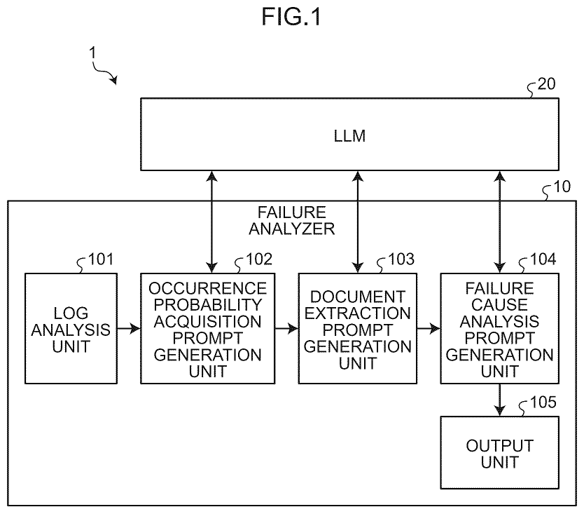

FIG. 1 is a block diagram of an estimation system according to a first embodiment. As illustrated in FIG. 1, an estimation system 1 includes a failure analyzer 10 and a large language model (LLM) 20.

The LLM 20 is a type of generated AI among machine learning models, and is a language model constructed using a large number of data sets and a deep learning technology. The LLM 20 is arranged in, for example, a server in a cloud environment.

Here, in the present embodiment, a case where the LLM 20, which is a large-scale language model, is used will be described as an example, but it is also possible to use a language model such as a small language model (SLM), multimodal generated AI capable of inputting and outputting images and tables, and the like.

The failure analyzer 10 acquires information on a failure that has occurred in a target system for which a failure cause is to be analyzed, and analyzes the failure using the LLM 20 to estimate the failure cause. The failure analyzer 10 is an information processing apparatus.

Details of the failure analyzer 10 will be described below. The failure analyzer 10 includes a log analysis unit 101, an occurrence probability acquisition prompt generation unit 102, a document extraction prompt generation unit 103, a failure cause analysis prompt generation unit 104, and an output unit 105. Here, the prompt is instruction information for outputting information to be obtained from the LLM 20.

The log analysis unit 101 receives an input of a query describing a failure content occurring in the target system. Then, the log analysis unit 101 specifies a log to be analyzed according to the acquired failure content. Next, the log analysis unit 101 acquires a log as an analysis target specified from logs of various events and operations of the target system. Here, the log analysis unit 101 may directly acquire the failure content and the log to be analyzed from the target system, or may acquire the failure content and the log by an input from an operator using an input device (not illustrated).

Next, the log analysis unit 101 analyzes the acquired log, and specifies a phrase and interprets contents included in the log. Thereafter, the log analysis unit 101 outputs the query describing the failure content and the analysis result of the log to the occurrence probability acquisition prompt generation unit 102.

In this manner, the log analysis unit 101 analyzes the log related to the failure to determine the failure classification of the failure content. More specifically, the log analysis unit 101 determines the failure classification using a failure analysis logic tree indicating the failure classification corresponding to the failure content. The failure analysis logic tree is, for example, a failure analysis logic tree automatically generated by the AI, a failure analysis logic tree generated on the basis of experience of an expert, or a failure analysis logic tree generated by modifying a logic tree automatically generated by the AI by an expert.

The occurrence probability acquisition prompt generation unit 102 has a failure classification logic tree in advance. The failure classification logic tree may be automatically created using LLM or AI, or may be created by utilizing experience knowledge by an expert. In addition, the failure classification logic tree may be created by creating a primary plan using LLM or AI and then slightly modifying the primary plan by an expert.

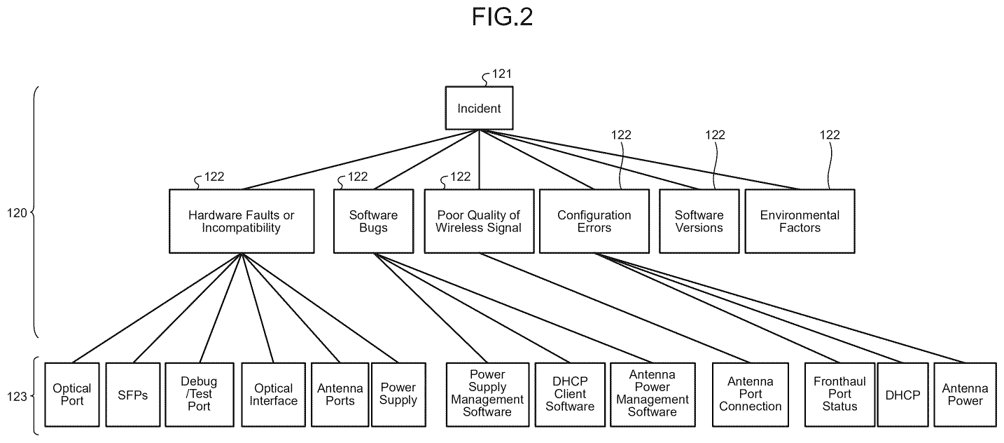

FIG. 2 is a diagram illustrating an example of a failure classification logic tree for a RU-DU interoperability test. Here, the RU-DU interoperability test is a test on interoperability of an RU and a DU in a network to which the RU and the DU are connected. A failure classification logic tree 120 in FIG. 2 is an example of a failure classification logic tree created for the use case of the “RU-DU interoperability test”, and is created by creating a primary plan by LLM and then making minor modifications by an expert. In FIG. 2, together with the failure classification logic tree 120, failure causes 123 considered as examples for each failure classification are also described.

The failure classification logic tree 120 is an example of a logic tree held by the occurrence probability acquisition prompt generation unit 102. The failure classification logic tree 120 has an occurred failure (Incident) in a root node 121, and failure classification nodes 122 indicating failure classifications considered as classifications of the failure are arranged below the root node 121. In the failure classification logic tree 120, an example has been described in which there is one hierarchy of the failure classification nodes 122, but the failure classification nodes 122 can also be arranged hierarchically. In addition, the failure cause 123 indicates a failure cause that can be a cause of occurrence of a failure corresponding to the failure classification for each failure classification. The failure cause 123 is an example of a failure cause finally obtained by the failure analyzer 10.

In FIG. 2, an item name of the failure classification is registered in each of the failure classification nodes 122. In the failure classification of the failure classification logic tree 120, for example, there are hardware faults or incompatibility and software bugs. In addition, the failure classification of the failure classification logic tree 120 includes poor quality of wireless signal, configuration errors, software versions, environmental factors, and the like.

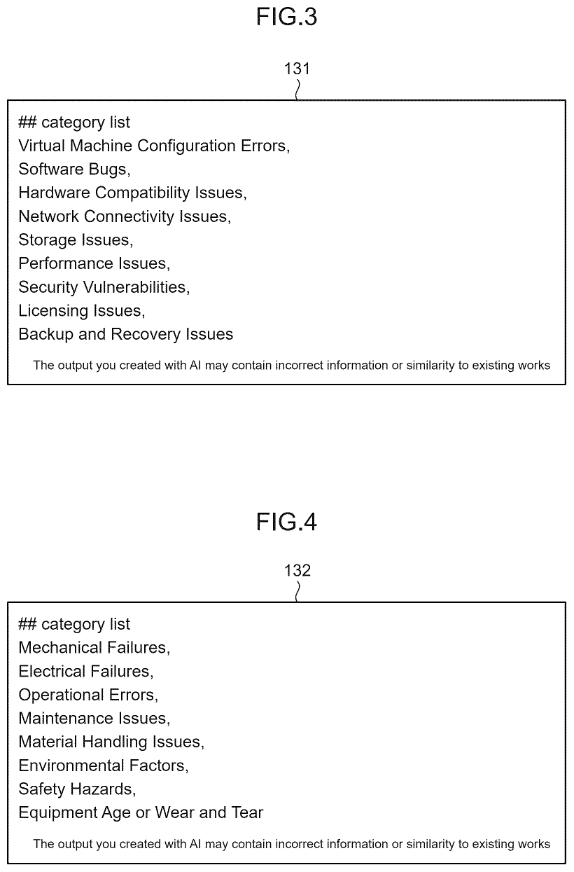

FIG. 3 is a diagram illustrating an example of a failure classification logic tree created using LLM. FIG. 4 is a diagram illustrating another example of the failure classification logic tree created using LLM.

A failure classification logic tree 131 in FIG. 3 is a failure classification logic tree for an application running on specific virtual machine software. The failure classification logic tree 131 lists item names of failure classifications for applications running on specific virtual machine software.

The failure classification in the failure classification logic tree 131 includes virtual machine configuration errors, software bugs, and hardware compatibility issues. In addition, the failure classification in the failure classification logic tree 131 includes network connectivity issues, software issues (Storage Issues), and performance issues. In addition, the failure classification of the failure classification logic tree 131 includes security vulnerabilities, licensing issues, backup and recovery issues, and the like.

A failure classification logic tree 132 of FIG. 4 is a failure classification logic tree for a belt conveyor in a plant. The failure classification logic tree 132 displays a list of item names of failure classifications for belt conveyors in the plant.

The failure classification in the failure classification logic tree 132 includes mechanical failures, electrical failures, and operational errors. In addition, the failure classification in the failure classification logic tree 132 includes maintenance issues, material handling issues, environmental factors, and safety hazards. In addition, in the failure classification of the failure classification logic tree 132, equipment age or wear and tear and the like also exist.

As described above, the item of the failure classification varies depending on the target system in which the failure occurs. In addition, the items of the failure classification are different depending on the generated failure. Therefore, the occurrence probability acquisition prompt generation unit 102 holds a failure classification logic tree for each target in which a failure has occurred and for each occurred failure.

Returning to FIG. 1, the description will be continued. The occurrence probability acquisition prompt generation unit 102 receives an input of a query describing a failure content and an analysis result of a log from the log analysis unit 101. Then, the occurrence probability acquisition prompt generation unit 102 generates an occurrence probability acquisition prompt for instructing to calculate the occurrence probability of the failure classification related to the occurred failure on the basis of the query describing the failure content, the analysis result of the log, and the failure classification logic tree for classifying the failure cause.

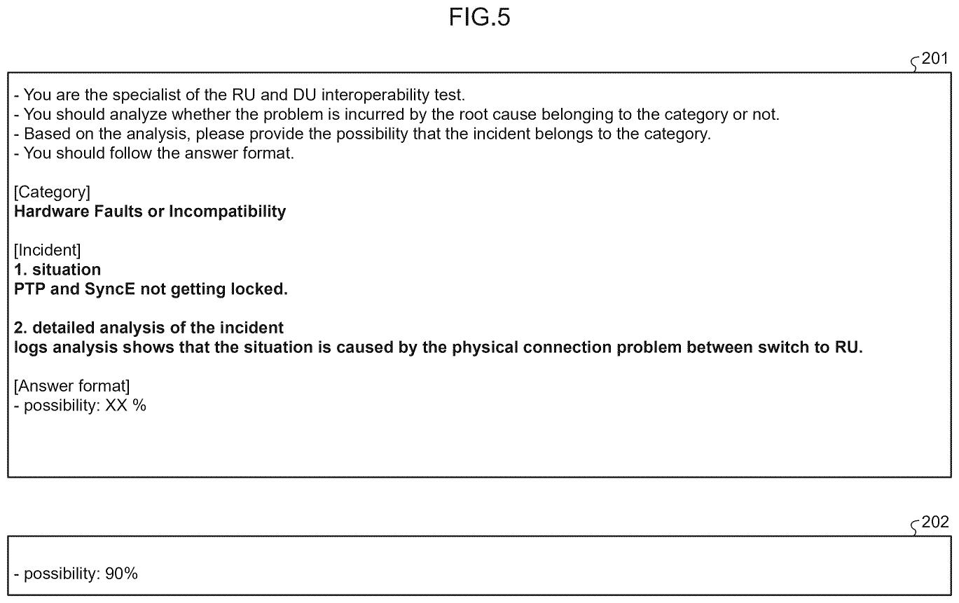

For example, the occurrence probability acquisition prompt generation unit 102 generates an occurrence probability acquisition prompt in the following procedure. FIG. 5 is a diagram illustrating an example of an occurrence probability acquisition prompt. For example, the occurrence probability acquisition prompt generation unit 102 has a format in which columns of a failure classification (Category) and a failure content (Incident) in an occurrence probability acquisition prompt 201 illustrated in FIG. 5 are not described. Hereinafter, this format is referred to as an occurrence probability acquisition prompt format.

The occurrence probability acquisition prompt generation unit 102 identifies a target in which a failure has occurred and the occurred failure from the query describing the failure content and the analysis results of the log. Next, the occurrence probability acquisition prompt generation unit 102 specifies the target in which the failure has occurred and the failure classification logic tree corresponding to the occurred failure.

Next, the occurrence probability acquisition prompt generation unit 102 selects one failure classification from the failure classifications registered in the specified failure classification logic tree. Next, the occurrence probability acquisition prompt generation unit 102 registers the selected failure classification in the failure classification field of the occurrence probability acquisition prompt format. Next, the occurrence probability acquisition prompt generation unit 102 registers the content of the failure that has occurred in the failure classification field of the occurrence probability acquisition prompt format. As described above, the occurrence probability acquisition prompt generation unit 102 generates the occurrence probability acquisition prompt 201.

Then, the occurrence probability acquisition prompt generation unit 102 inputs the generated occurrence probability acquisition prompt to the LLM 20. Thereafter, the occurrence probability acquisition prompt generation unit 102 acquires the occurrence probability of each failure classification related to the occurred failure as the inference result output from the LLM 20.

For example, in a case where the occurrence probability acquisition prompt 201 in FIG. 5 is input, the occurrence probability acquisition prompt generation unit 102 acquires a response 202 from the LLM 20. In this case, the occurrence probability acquisition prompt generation unit 102 acquires 90% as the occurrence probability of the failure classification of the hardware faults or incompatibility.

The occurrence probability acquisition prompt generation unit 102 acquires the occurrence probability of the failure classification for all the failure classifications in the specified failure classification logic tree. Then, the occurrence probability acquisition prompt generation unit 102 outputs each occurrence probability of the failure classification related to the occurred failure to the document extraction prompt generation unit 103. In addition, the occurrence probability acquisition prompt generation unit 102 outputs the query describing the failure content and the analysis result of the log to the document extraction prompt generation unit 103.

The occurrence probability acquisition prompt generation unit 102 corresponds to an example of a “third inference execution unit”. Then, the occurrence probability acquisition prompt generation unit 102 causes the LLM 20, which is a machine learning model, to infer the occurrence probability for each of the failure classifications.

The document extraction prompt generation unit 103 receives, from the occurrence probability acquisition prompt generation unit 102, an input of an occurrence probability for each failure classification related to the occurred failure. In addition, the document extraction prompt generation unit 103 receives an input of a query describing a failure content and an analysis result of a log from the occurrence probability acquisition prompt generation unit 102. Here, the document extraction prompt generation unit 103 has a threshold of the occurrence probability of the failure classification. The document extraction prompt generation unit 103 specifies a failure classification whose occurrence probability of the failure classification exceeds a threshold.

Next, the document extraction prompt generation unit 103 receives an input of a technical document for the failure. The technical document of the failure classification is a specification of a device in which a failure occurs or a target system. Then, the document extraction prompt generation unit 103 generates a document extraction prompt for instructing extraction of a sentence chunk in which the failure cause in each failure classification is described on the basis of the item name of the failure classification and the technical document for each of the specified failure classifications.

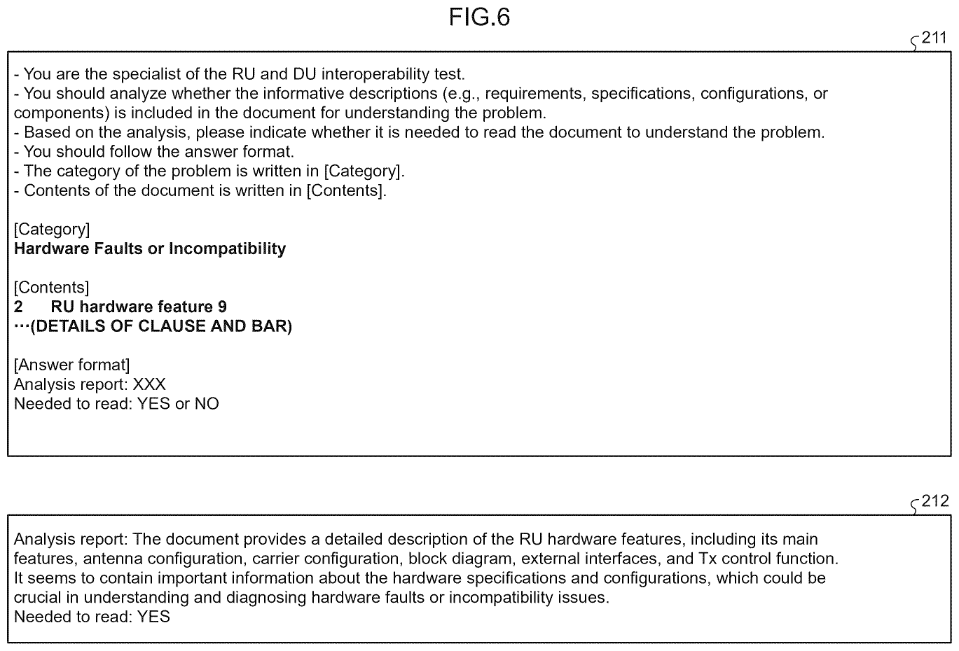

For example, the document extraction prompt generation unit 103 generates a document extraction prompt in the following procedure. FIG. 6 is a diagram illustrating an example of a document extraction prompt. For example, the document extraction prompt generation unit 103 has a format in which columns of a failure classification (Category) and a technical document (Contents) in a document extraction prompt 211 illustrated in FIG. 6 are not described. Hereinafter, this format is referred to as a document extraction prompt format.

The document extraction prompt generation unit 103 selects one failure classification from the failure classifications in which the occurrence probability of the failure classification exceeds the threshold. Next, the document extraction prompt generation unit 103 registers the selected failure classification in the failure classification field of the document extraction prompt format. Next, the document extraction prompt generation unit 103 registers the contents of the technical document in the technical document field in the document extraction prompt format. As described above, the document extraction prompt generation unit 103 generates the document extraction prompt 211.

Then, the document extraction prompt generation unit 103 inputs the generated document extraction prompt to the LLM 20. Thereafter, the document extraction prompt generation unit 103 acquires the sentence chunk, which is the relevant portion in the technical document regarding the failure cause in the failure classification, which is the inference result output from the LLM 20. The document chunk is a bundle of sentences, and is, for example, one sentence, paragraph, clause, bar, or the like.

For example, in a case where the document extraction prompt 211 in FIG. 6 is input, the document extraction prompt generation unit 103 obtains a response 212 from the LLM 20. In this case, the document extraction prompt generation unit 103 acquires the sentence chunk described in the response 212 as a document chunk for the a failure cause in the hardware faults or incompatibility.

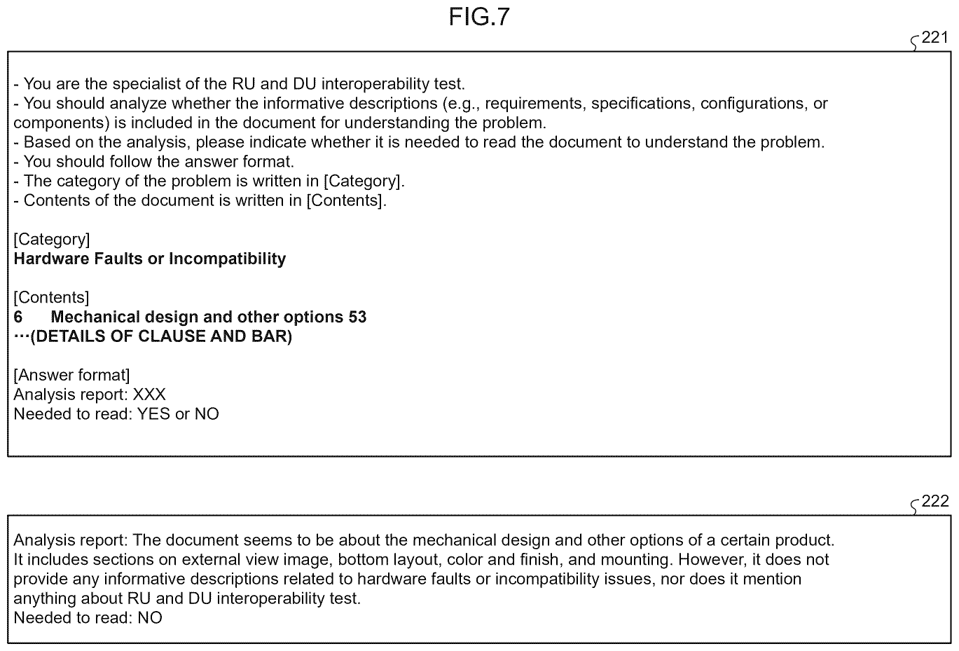

FIG. 7 is a diagram illustrating another example of the document extraction prompt. FIG. 7 illustrates an example of a case where there is no appropriate sentence chunk for the input failure classification and extraction is not performed. For example, the document extraction prompt generation unit 103 acquires a response 222 from the LLM 20 by inputting a document extraction prompt 221 in FIG. 7. In this case, the document extraction prompt generation unit 103 acquires the response 222 describing that the appropriate sentence chunk has not been extracted.

The document extraction prompt generation unit 103 acquires a sentence chunk in which the failure cause is described for all the failure classifications in which the occurrence probability of the failure classification exceeds the threshold. Then, the document extraction prompt generation unit 103 outputs the sentence chunk describing the failure cause to the failure cause analysis prompt generation unit 104. In addition, the document extraction prompt generation unit 103 outputs the query describing the failure content, the analysis result of the log, and the information of the failure classification as the target of the document chunk extraction to the failure cause analysis prompt generation unit 104.

Here, in the present embodiment, the case where the document extraction prompt generation unit 103 causes the LLM 20 to read the entire technical document and extract the document chunk has been described, but the inference method of the LLM 20 is not limited thereto. For example, the document extraction prompt generation unit 103 may cause the LLM 20 to read the content information of the technical document and extract the document chunk. In this case, the chapter related to the occurred failure is extracted by the LLM 20, and the document extraction prompt generation unit 103 obtains information of the chapter related to the occurred failure.

The document extraction prompt generation unit 103 corresponds to an example of a “first inference execution unit”. In addition, the sentence chunk in which the failure cause in the failure classification is described corresponds to an example of the “corresponding sentence corresponding to the failure classification”. The technical document of the failure classification corresponds to an example of the “predetermined technical document”. The document extraction prompt generation unit 103 causes the LLM 20, which is a machine learning model, to extract the corresponding sentence corresponding to the failure classification determined by the log analysis unit 101 from the predetermined technical document.

Furthermore, the document extraction prompt generation unit 103 generates a sentence extraction prompt for causing the LLM 20 to extract a corresponding sentence from a predetermined technical document, inputs the generated sentence extraction prompt to the LLM 20, and outputs the corresponding sentence from the LLM 20. In addition, the document extraction prompt generation unit 103 causes the LLM 20 to extract the corresponding sentence corresponding to the failure classification the occurrence probability of which is equal to or greater than the threshold value. The document extraction prompt generation unit 103 causes the LLM 20 to extract a sentence related to the failure classification as a corresponding sentence using a technical document including at least the specification of the system in which the failure has occurred.

The failure cause analysis prompt generation unit 104 receives an input of the sentence chunk in which the failure cause is described from the document extraction prompt generation unit 103. In addition, the failure cause analysis prompt generation unit 104 receives, from the document extraction prompt generation unit 103, an input of a query describing a failure content, an analysis result of a log, and information of a failure classification as a target of document chunk extraction. Then, the failure cause analysis prompt generation unit 104 generates a failure cause analysis prompt for instructing to enumerate the failure causes from the viewpoint of the failure classification on the basis of the query describing the failure content, the analysis result of the log, the item name of the failure classification, and the sentence chunk.

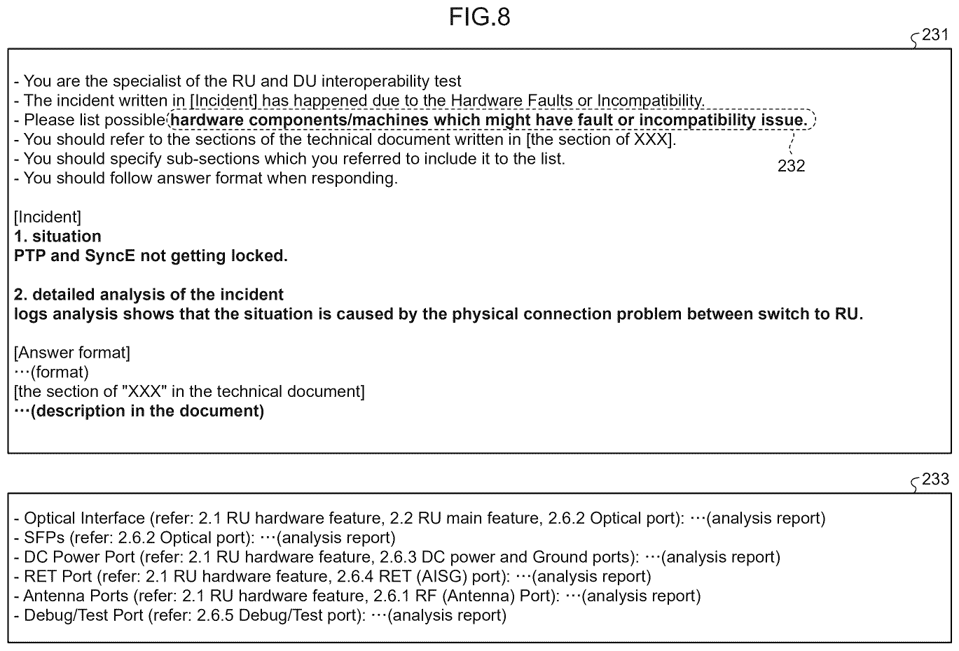

For example, the failure cause analysis prompt generation unit 104 generates a failure cause analysis prompt in the following procedure. FIG. 8 is a diagram illustrating an example of a failure cause analysis prompt. For example, the failure cause analysis prompt generation unit 104 has a format in which a region 232 describing a failure classification and a field of an occurred failure (Incident) in a failure cause analysis prompt 231 illustrated in FIG. 8 are not described. Hereinafter, this format is referred to as a failure cause analysis prompt format.

The failure cause analysis prompt generation unit 104 selects one failure classification from the failure classifications from which the sentence chunk has been extracted. Next, the failure cause analysis prompt generation unit 104 registers the selected failure classification in the region 232. Next, the failure cause analysis prompt generation unit 104 registers the contents of the failure that has occurred in the failure field. As described above, the failure cause analysis prompt generation unit 104 generates the failure cause analysis prompt 231.

Then, the failure cause analysis prompt generation unit 104 inputs a sentence chunk in which the generated failure cause analysis prompt and the failure cause in the failure classification are described to the LLM 20. Thereafter, the failure cause analysis prompt generation unit 104 acquires a list of failure causes in the selected failure classification as the inference result output from the LLM 20.

For example, in a case where the failure cause analysis prompt 231 in FIG. 8 is input, the failure cause analysis prompt generation unit 104 obtains a response 233 from the LLM 20. In this case, the failure cause analysis prompt generation unit 104 acquires a list of failure causes indicated in the response 233.

The failure cause analysis prompt generation unit 104 acquires a list of failure causes for all the failure classifications from which the document chunk has been extracted. Then, the failure cause analysis prompt generation unit 104 outputs a list of all the acquired failure causes to the output unit 105.

The failure cause analysis prompt generation unit 104 corresponds to an example of a “second inference execution unit”. In other words, the failure cause analysis prompt generation unit 104 causes the LLM 20 to infer the failure cause on the basis of the corresponding sentence extracted by the LLM 20 as the machine learning model caused by the document extraction prompt generation unit 103 as the first inference execution unit. In addition, the failure cause analysis prompt generation unit 104 generates a failure cause analysis prompt for inferring the failure cause on the basis of the corresponding sentence, inputs the generated failure cause analysis prompt to the LLM 20, and outputs the failure cause from the LLM 20. The failure cause analysis prompt generation unit 104 causes the LLM 20 to infer a plurality of items as failure causes and outputs a list of the items of failure causes from the LLM 20.

The output unit 105 receives an input of the list of failure causes from the failure cause analysis prompt generation unit 104. Then, the output unit 105 displays a list of failure causes on a display device such as a monitor (not illustrated) and provides the list to the user. In addition, the output unit 105 may provide the list of failure causes to the user by transmitting the list of failure causes to the information terminal device of the user and displaying the list on the screen.

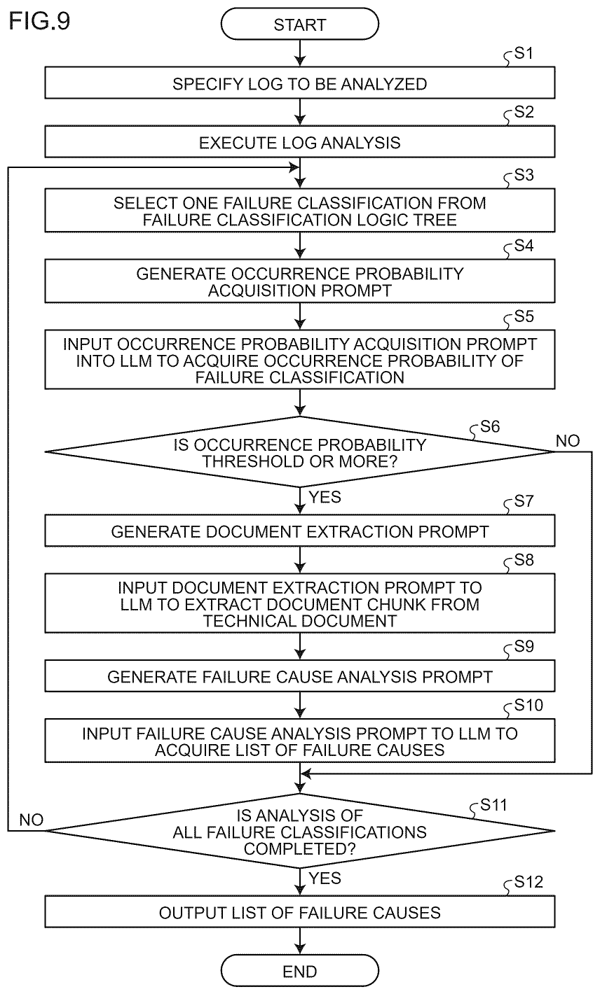

FIG. 9 is a flowchart of failure cause analysis processing by the estimation system according to the first embodiment. Next, a flow of the failure cause analysis processing by the estimation system 1 according to the first embodiment will be described with reference to FIG. 9.

The log analysis unit 101 receives an input of a failure content occurring in the target system. Then, the log analysis unit 101 specifies a log to be analyzed according to the acquired failure content (Step S1).

The log analysis unit 101 acquires the specified log, executes log analysis, and specifies a phrase and interprets contents included in the log (Step S2).

The occurrence probability acquisition prompt generation unit 102 receives an input of a query describing a failure content and an analysis result of a log from the log analysis unit 101. Next, the occurrence probability acquisition prompt generation unit 102 specifies a failure classification logic tree used for analysis from a query describing a failure content, an analysis result of a log, and a failure cause. Then, the occurrence probability acquisition prompt generation unit 102 selects one failure classification from the specified failure classification logic tree (Step S3).

Next, the occurrence probability acquisition prompt generation unit 102 generates an occurrence probability acquisition prompt for instructing to calculate an occurrence probability of a failure classification related to the occurred failure on the basis of the selected failure classification and the query describing the failure content (Step S4).

Next, the occurrence probability acquisition prompt generation unit 102 inputs the generated occurrence probability acquisition prompt to the LLM 20. Then, the occurrence probability acquisition prompt generation unit 102 acquires the occurrence probability of the selected failure classification output from the LLM 20 (Step S5).

The document extraction prompt generation unit 103 determines whether the occurrence probability of the selected failure classification is equal to or larger than a threshold (Step S6). In a case where the occurrence probability of the selected failure classification is less than the threshold (Step S6: No), the failure cause analysis processing proceeds to Step S11.

On the other hand, in a case where the occurrence probability of the selected failure classification is equal to or larger than the threshold (Step S6: Yes), the document extraction prompt generation unit 103 generates a document extraction prompt to instruct extraction of the sentence chunk on the basis of the item name of the failure classification and the technical document (Step S7).

Next, the document extraction prompt generation unit 103 inputs the generated document extraction prompt to the LLM 20. Then, the document extraction prompt generation unit 103 extracts the document chunk, which is output from the LLM 20 and in which the failure cause related to the selected failure classification is described, from the technical document (Step S8).

The failure cause analysis prompt generation unit 104 receives an input of the sentence chunk in which the failure cause is described from the document extraction prompt generation unit 103. Then, the failure cause analysis prompt generation unit 104 generates a failure cause analysis prompt on the basis of the query describing the failure content, the analysis result of the log, the item name of the failure classification, and the sentence chunk (Step S9).

Next, the failure cause analysis prompt generation unit 104 inputs a sentence chunk in which the generated failure cause analysis prompt and the failure cause in the failure classification are described to the LLM 20. Then, the failure cause analysis prompt generation unit 104 acquires a list of failure causes output from the LLM 20 (Step S10).

The occurrence probability acquisition prompt generation unit 102 determines whether analysis for all failure classifications in the specified failure analysis logic tree has been completed (Step S11). In a case where there remains a failure classification that has not been analyzed (Step S11: No), the failure cause analysis processing returns to Step S3.

On the other hand, in a case where no failure classification that has not been analyzed remains (Step S11: Yes), the output unit 105 outputs a list of failure causes and provides the list to the user (Step S12).

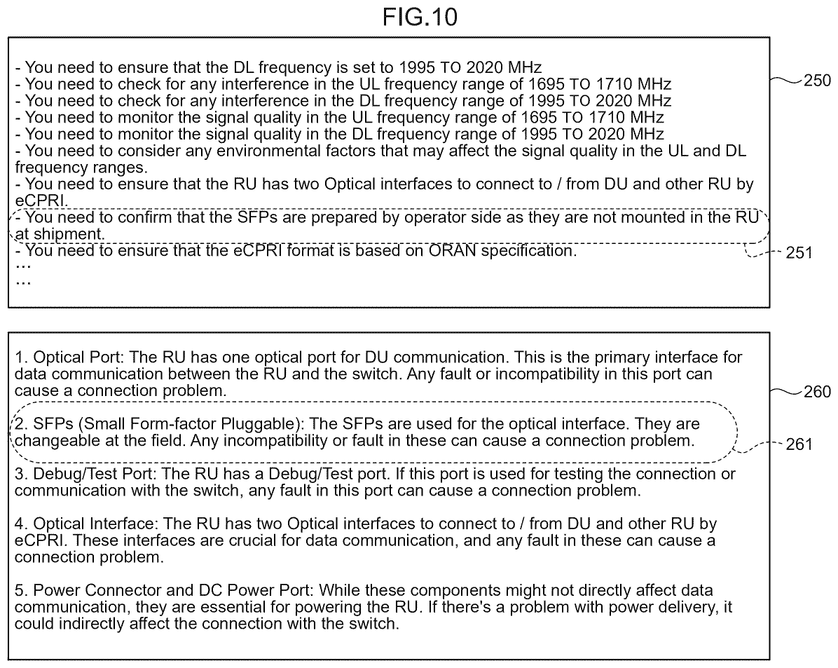

FIG. 10 is a diagram illustrating comparison of estimation results between a case of simple LLM replacement and a case of using the estimation system according to the first embodiment. The case of simple LLM replacement is a case where in-context learning (ICL) for instructing failure cause analysis is performed by inputting contents of a specification or the like into a prompt to the LLM. Next, a comparison of inference results between a case of simple LLM replacement and a case of using the estimation system 1 according to the present embodiment will be described with reference to FIG. 10.

Here, a case where a failure cause analysis is performed for a failure in which an “SFP (Small Form-factor Pluggable) compatibility problem” occurs will be described as an example. A failure cause list 250 is an inference result in the case of simple LLM replacement. In addition, a failure cause list 260 is an inference result in a case where the estimation system 1 according to the present embodiment is used.

The failure cause list 250 in the case of simple LLM replacement includes a failure cause 251 corresponding to an answer close to the correct answer that is the actual failure cause. In addition, the failure cause list 260 in the case of using the estimation system 1 according to the present embodiment includes a failure cause 261 corresponding to an answer close to the correct answer that is the actual failure cause.

As described above, an answer close to the correct answer can be provided in any case, but several hundreds of failure causes are described in the failure cause list 250 in the case of simple LLM replacement. On the other hand, five failure causes are described in the failure cause list 260 in the case of using the estimation system 1 according to the present embodiment. That is, by using the estimation system 1 according to the present embodiment, noise can be greatly reduced from among failure causes provided as inference results, and the user can easily identify a correct failure cause.

As described above, the estimation system according to the present embodiment generates a sentence extraction prompt along the failure classification logic tree prepared in advance and generates a failure cause analysis prompt from each failure classification viewpoint. Then, the estimation system according to the present embodiment causes the LLM, which is the generated AI, to perform inference in stages using the generated prompt and specifies the failure cause.

As a result, it is possible to perform the failure analysis by giving the logical thinking power to the generated AI, and it is possible to enumerate various possible failure causes. Therefore, it is possible to improve the identification accuracy of the failure cause.

### (b) Second Embodiment

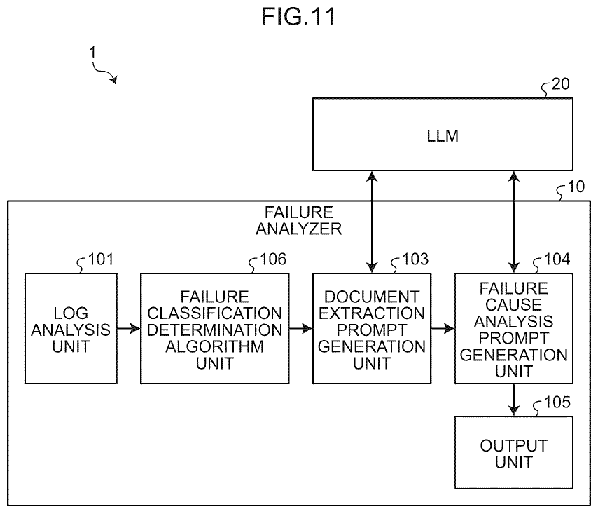

FIG. 11 is a block diagram of an estimation system according to a second embodiment. In the present embodiment, it is assumed that there is sufficient teacher data and experience knowledge for performing failure classification. The failure analyzer 10 in the estimation system 1 according to the present embodiment calculates the occurrence probability of the failure classification using an existing failure classification technology instead of the LLM 20. In the following description, description of operation of each unit similar to that of the first embodiment will be omitted.

As illustrated in FIG. 11, the failure analyzer 10 according to the present embodiment includes a log analysis unit 101, a document extraction prompt generation unit 103, a failure cause analysis prompt generation unit 104, an output unit 105, and a failure classification determination algorithm unit 106.

The failure classification determination algorithm unit 106 includes a failure classification determination algorithm for performing failure classification of a failure occurring using teacher data and experience knowledge. For example, the failure classification determination algorithm unit 106 may perform failure classification using a given decision tree algorithm. In addition, the failure classification determination algorithm unit 106 can perform failure classification by an expert system that automatically generates a decision tree algorithm from a given if-then rule and performs failure classification using the generated decision tree algorithm. In addition, the failure classification determination algorithm unit 106 can also use classification AI such as cross-iteration batch normalization (CBN), self-organizing map (SOM), or neural network (NN) other than the LLM. In this case, the failure classification determination algorithm unit 106 can cause the classification AI to learn using the log data of the failure case that has occurred in the past and infer the failure classification of the failure that has occurred using the learned classification AI.

The failure classification determination algorithm unit 106 receives an input of a query describing a failure content and an analysis result of a log from the log analysis unit 101. Then, the failure classification determination algorithm unit 106 uses a failure classification determination algorithm to specify a failure classification of a failure that has occurred on the basis of a query describing a failure content, an analysis result of a log, and a failure classification logic tree for classifying a failure cause, and acquires an occurrence probability for each specified failure classification.

Then, the failure classification determination algorithm unit 106 outputs the occurrence probability of the failure classification related to the occurred failure, the query describing the failure content, and the analysis result of the log to the document extraction prompt generation unit 103.

The document extraction prompt generation unit 103 generates a document extraction prompt on the basis of the query describing the failure content, the analysis result of the log, and the occurrence probability of the failure classification. Then, the document extraction prompt generation unit 103 inputs the generated document extraction prompt to the LLM 20 and acquires the sentence chunk in which the failure cause is described. In addition, the failure cause analysis prompt generation unit 104 generates a failure cause analysis prompt on the basis of the item name of the failure classification and the sentence chunk describing the failure cause in each failure classification. Then, the failure cause analysis prompt generation unit 104 inputs the failure cause analysis prompt to the LLM 20 and acquires a list of failure causes for all the failure classifications from which the document chunk has been extracted.

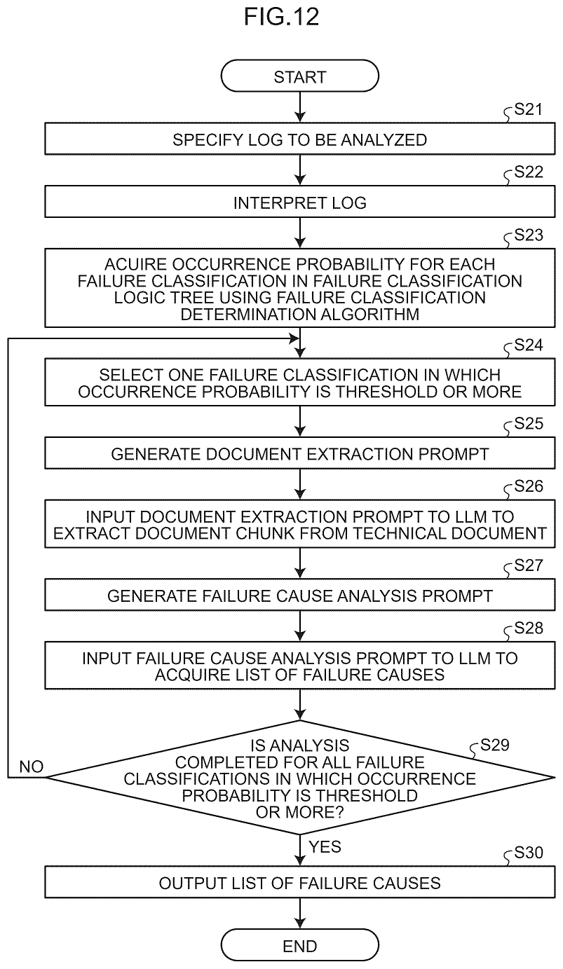

FIG. 12 is a flowchart of failure cause analysis processing by the estimation system according to the second embodiment. Next, a flow of failure cause analysis processing by the estimation system 1 according to the second embodiment will be described with reference to FIG. 12.

The log analysis unit 101 receives an input of a failure content occurring in the target system. Then, the log analysis unit 101 specifies a log to be analyzed according to the acquired failure content (Step S21).

The log analysis unit 101 acquires the specified log, executes log analysis, and specifies a phrase and interprets contents included in the log (Step S22).

The failure classification determination algorithm unit 106 receives an input of a query describing a failure content and an analysis result of a log from the log analysis unit 101. Then, the failure classification determination algorithm unit 106 uses a failure classification determination algorithm to specify a failure classification of a failure that has occurred on the basis of a query describing a failure content, an analysis result of a log, and a failure classification logic tree, and acquires an occurrence probability for each specified failure classification (Step S23).

The document extraction prompt generation unit 103 selects one failure classification whose occurrence probability is equal to or greater than a threshold (Step S24).

Next, the document extraction prompt generation unit 103 generates a document extraction prompt to instruct extraction of the sentence chunk on the basis of the item name of the failure classification and the technical document (Step S25).

Next, the document extraction prompt generation unit 103 inputs the generated document extraction prompt to the LLM 20. Then, the document extraction prompt generation unit 103 extracts the document chunk, which is output from the LLM 20 and in which the failure cause related to the selected failure classification is described, from the technical document (Step S26).

The failure cause analysis prompt generation unit 104 receives an input of the sentence chunk in which the failure cause is described from the document extraction prompt generation unit 103. Then, the failure cause analysis prompt generation unit 104 generates a failure cause analysis prompt on the basis of the query describing the failure content, the analysis result of the log, the item name of the failure classification, and the sentence chunk (Step S27).

Next, the failure cause analysis prompt generation unit 104 inputs a sentence chunk in which the generated failure cause analysis prompt and the failure cause in the failure classification are described to the LLM 20. Thereafter, the failure cause analysis prompt generation unit 104 acquires a list of failure causes output from the LLM 20 (Step S28).

Thereafter, the occurrence probability acquisition prompt generation unit 102 determines whether analysis has been completed for all the failure classifications having an occurrence probability equal to or greater than the threshold (Step S29). In a case where there remains a failure classification that has not been analyzed (Step S29: No), the failure cause analysis processing returns to Step S24.

On the other hand, in a case where no failure classification that has not been analyzed remains (Step S29: Yes), the output unit 105 outputs a list of failure causes and provides the list to the user (Step S30).

As described above, the estimation system according to the present embodiment performs the failure classification using the failure classification algorithm instead of the LLM, and generates the sentence extraction prompt and the failure cause analysis prompt on the basis of the failure classification. Then, the estimation system according to the present embodiment causes the LLM, which is the generated AI, to perform inference in stages using the generated prompt and specifies the failure cause.

As described above, in a case where there is sufficient data and experience knowledge for performing the failure classification, it is possible to perform the failure classification without using the LLM, to perform the failure analysis by giving the logical thinking power to the generated AI, and to improve the identification accuracy of the failure cause.

### (c) Third Embodiment

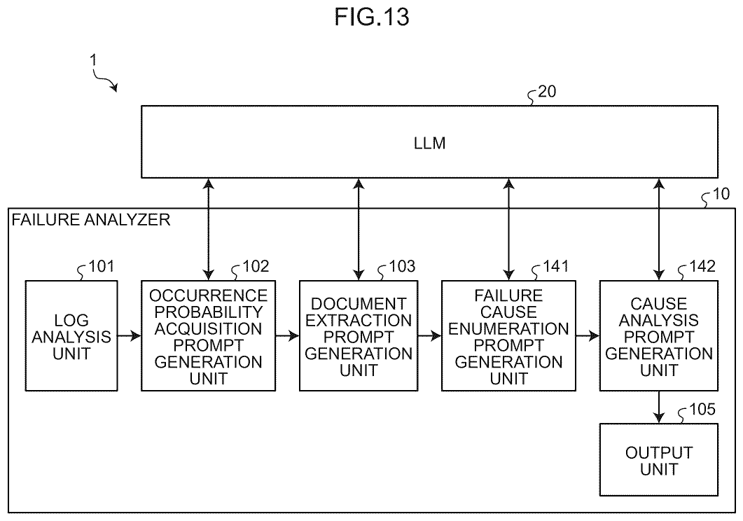

FIG. 13 is a block diagram of an estimation system according to the third embodiment. By assigning a viewpoint of failure classification and causing inference to be performed using the extracted document chunks, it is possible to support failure cause analysis by the LLM 20. In addition, it is possible to improve the identification accuracy of the failure cause by generating a prompt for clearly indicating the answer basis rather than simply generating a prompt for instructing failure analysis.

The failure analyzer 10 in the estimation system 1 according to the present embodiment divides generation of a prompt for failure cause identification based on the document chunk into two stages. The failure analyzer 10 generates a prompt to list all possible failure causes in the first stage. Then, in the second stage, the failure analyzer 10 generates a prompt to infer again how likely each listed failure cause is. In the following description, description of operation of each unit similar to that of the first embodiment will be omitted.

As illustrated in FIG. 13, the failure analyzer 10 according to the present embodiment includes a log analysis unit 101, an occurrence probability acquisition prompt generation unit 102, a document extraction prompt generation unit 103, a failure cause enumeration prompt generation unit 141, a cause analysis prompt generation unit 142, and an output unit 105.

The failure cause enumeration prompt generation unit 141 receives an input of the sentence chunk in which the failure cause is described from the document extraction prompt generation unit 103. In addition, the failure cause enumeration prompt generation unit 141 receives, from the document extraction prompt generation unit 103, an input of a query describing a failure content, an analysis result of a log, and information of a failure classification as a target of document chunk extraction.

Then, the failure cause enumeration prompt generation unit 141 generates a failure cause enumeration prompt for instructing to enumerate the failure causes from the viewpoint of the failure classification on the basis of the query describing the failure content, the analysis result of the log, the item name of the failure classification, and the sentence chunk. For example, the failure cause enumeration prompt generation unit 141 can generate the failure cause enumeration prompt in a similar procedure as the generation of the failure cause analysis prompt by the failure cause analysis prompt generation unit 104.

The failure cause enumeration prompt generation unit 141 inputs the failure cause enumeration prompt to the LLM 20 to acquire a list of failure causes for all the failure classifications from which the document chunk has been extracted. Then, the failure cause enumeration prompt generation unit 141 outputs the acquired list of all failure causes to the cause analysis prompt generation unit 142. In addition, the failure cause enumeration prompt generation unit 141 outputs, to the cause analysis prompt generation unit 142, the query describing the failure content, the analysis result of the log, and the information of the failure classification as the target of the document chunk extraction.

The cause analysis prompt generation unit 142 receives an input of a list of all failure causes from the document extraction prompt generation unit 103. In addition, the cause analysis prompt generation unit 142 receives, from the failure cause enumeration prompt generation unit 141, an input of a query describing a failure content, an analysis result of a log, and information of a failure classification as a target of document chunk extraction.

Then, the cause analysis prompt generation unit 142 generates a cause analysis prompt that instructs presentation of the possibility of each failure cause registered in the list of failure causes and the basis thereof.

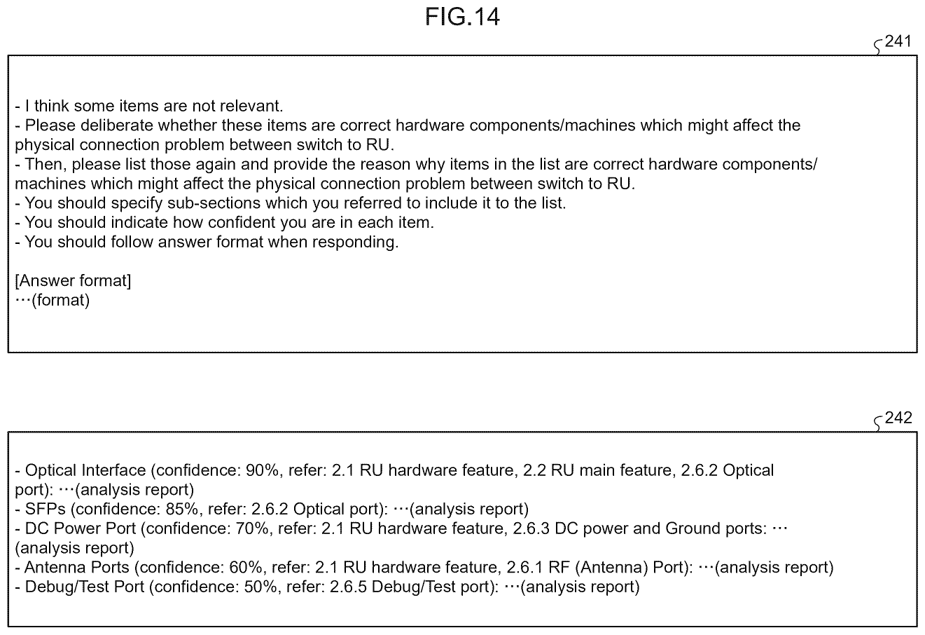

FIG. 14 is a diagram illustrating an example of a cause analysis prompt. For example, the cause analysis prompt generation unit 142 may generate a cause analysis prompt 241 that instructs provision of a probability that each failure cause can be a cause and a basis thereof. In this case, by inputting the cause analysis prompt 241, the cause analysis prompt generation unit 142 can acquire, from the LLM 20, a response 242 indicating the probability that each failure cause can be a cause and the basis thereof.

Here, the failure cause enumeration prompt generation unit 141 and the cause analysis prompt generation unit 142 correspond to an example of a “second inference execution unit”. Then, the failure cause enumeration prompt generation unit 141 and the cause analysis prompt generation unit 142 cause the LLM 20 to clearly indicate the basis for inferring the failure cause.

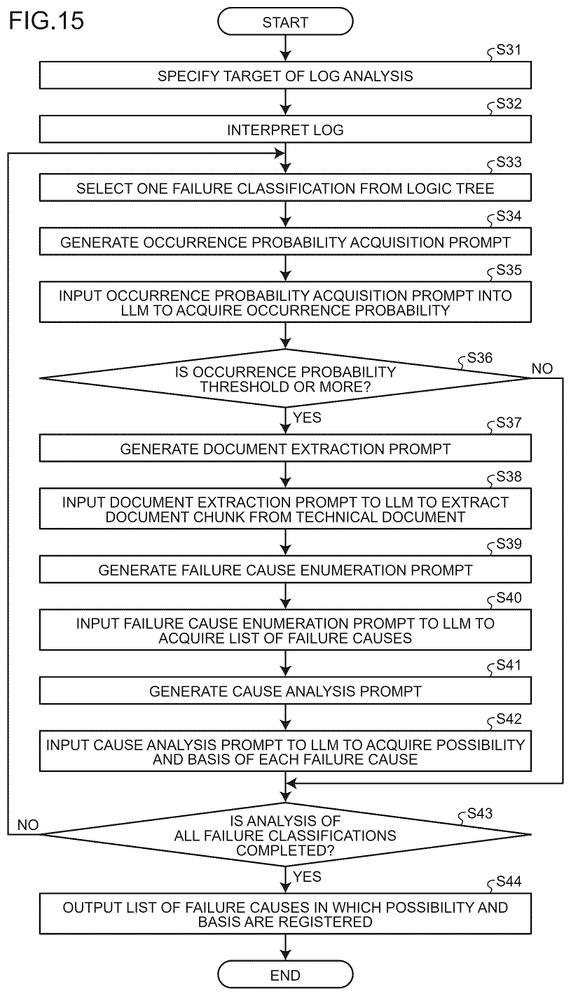

FIG. 15 is a flowchart of failure cause analysis processing by the estimation system according to the third embodiment. Next, a flow of failure cause analysis processing by the estimation system 1 according to the third embodiment will be described with reference to FIG. 15.

The log analysis unit 101 receives an input of a failure content occurring in the target system. Then, the log analysis unit 101 specifies a log to be analyzed according to the acquired failure content (Step S31).

The log analysis unit 101 acquires the specified log, executes log analysis, and specifies a phrase and interprets contents included in the log (Step S32).

The occurrence probability acquisition prompt generation unit 102 receives an input of a query describing a failure content and an analysis result of a log from the log analysis unit 101. Next, the occurrence probability acquisition prompt generation unit 102 specifies a failure classification logic tree used for analysis from a query describing a failure content, an analysis result of a log, and a failure cause. Then, the occurrence probability acquisition prompt generation unit 102 selects one failure classification from the specified failure classification logic tree (Step S33).

Next, the occurrence probability acquisition prompt generation unit 102 generates an occurrence probability acquisition prompt for instructing to calculate an occurrence probability of a failure classification related to the occurred failure on the basis of the selected failure classification and the query describing the failure content (Step S34).

Next, the occurrence probability acquisition prompt generation unit 102 inputs the generated occurrence probability acquisition prompt to the LLM 20. Then, the occurrence probability acquisition prompt generation unit 102 acquires the occurrence probability of the selected failure classification output from the LLM 20 (Step S35).

The document extraction prompt generation unit 103 determines whether the occurrence probability of the selected failure classification is equal to or larger than a threshold (Step S36). In a case where the occurrence probability of the selected failure classification is less than the threshold (Step S36: No), the failure cause analysis processing proceeds to Step S43.

On the other hand, in a case where the occurrence probability of the selected failure classification is equal to or larger than the threshold (Step S36: Yes), the document extraction prompt generation unit 103 generates a document extraction prompt to instruct extraction of the sentence chunk on the basis of the item name of the failure classification and the technical document (Step S37).

Next, the document extraction prompt generation unit 103 inputs the generated document extraction prompt to the LLM 20. Then, the document extraction prompt generation unit 103 extracts the document chunk, which is output from the LLM 20 and in which the failure cause related to the selected failure classification is described, from the technical document (Step S38).

The failure cause enumeration prompt generation unit 141 receives an input of the sentence chunk in which the failure cause is described from the document extraction prompt generation unit 103. Then, the failure cause enumeration prompt generation unit 141 generates a failure cause enumeration prompt on the basis of the query describing the failure content, the analysis result of the log, the item name of the failure classification, and the sentence chunk (Step S39).

Next, the failure cause enumeration prompt generation unit 141 inputs a sentence chunk in which the generated failure cause enumeration prompt and the failure cause in the failure classification are described to the LLM 20. Thereafter, the failure cause enumeration prompt generation unit 141 acquires a list of failure causes output from the LLM 20 (Step S40).

The cause analysis prompt generation unit 142 receives an input of a list of the failure causes from the document extraction prompt generation unit 103. Then, the failure cause enumeration prompt generation unit 141 generates a cause analysis prompt on the basis of the query describing the failure content, the analysis result of the log, the item name of the failure classification, and the list of failure causes (Step S41).

Next, the cause analysis prompt generation unit 142 inputs the generated cause analysis prompt and the list of failure causes to the LLM 20. Thereafter, the cause analysis prompt generation unit 142 acquires the possibility and the basis of each failure cause output from the LLM 20 (Step S42).

Thereafter, the occurrence probability acquisition prompt generation unit 102 determines whether analysis for all failure classifications in the specified failure analysis logic tree has been completed (Step S43). In a case where there remains a failure classification that has not been analyzed (Step S43: No), the failure cause analysis processing returns to Step S33.

On the other hand, in a case where no failure classification that has not been analyzed remains (Step S43: Yes), the output unit 105 outputs a list of failure causes in which the respective possibilities and bases thereof are registered, and provides the list to the user (Step S44).

As described above, in the analysis of the failure cause, the estimation system according to the present embodiment outputs a list of possible failure causes from the LLM, and then causes the LLM to provide the possibility of each failure cause and the basis thereof. In this manner, it is possible to improve the identification accuracy of the failure cause by separating the task of listing the possible failure causes and the task of considering them.

### Modification

In the third embodiment, the failure cause analysis prompt generated in the first embodiment is divided into two-stage prompts to improve the identification accuracy of the failure cause, but it is also possible to perform other processing on the failure cause analysis prompt to improve the identification accuracy of the failure cause.

For example, information indicating a series of procedures (thought process: Chain of thoughts) until solving a problem may be added to the failure cause analysis prompt generated in the first embodiment. For example, the failure cause analysis prompt generation unit 104 in FIG. 1 can introduce Chain of thoughts by adding a word such as “Think step by step” to the generated failure cause analysis prompt. By using such a failure cause analysis prompt, the LLM 20 can more logically derive the failure cause, and the identification accuracy of the failure cause can be improved.

In addition, Tree of thoughts may be introduced into the failure cause analysis prompt generated in the first embodiment. For example, the failure cause analysis prompt generation unit 104 in FIG. 1 defines a plurality of expert instances, causes each expert to enumerate failure causes, and generates a failure cause analysis prompt that causes the experts to discuss the possibility and propriety thereof. As a result, the failure cause analysis prompt generation unit 104 can generate a failure cause analysis prompt into which Tree of thoughts is introduced. The failure cause analysis prompt into which Tree of thoughts is introduced causes the LLM 20 to perform a process similar to the process of automatically performing two tasks such as a task of listing failure causes and a task of performing analysis for each listed failure cause. As a result, the identification accuracy of the failure cause can be improved.

### (d) Fourth Embodiment

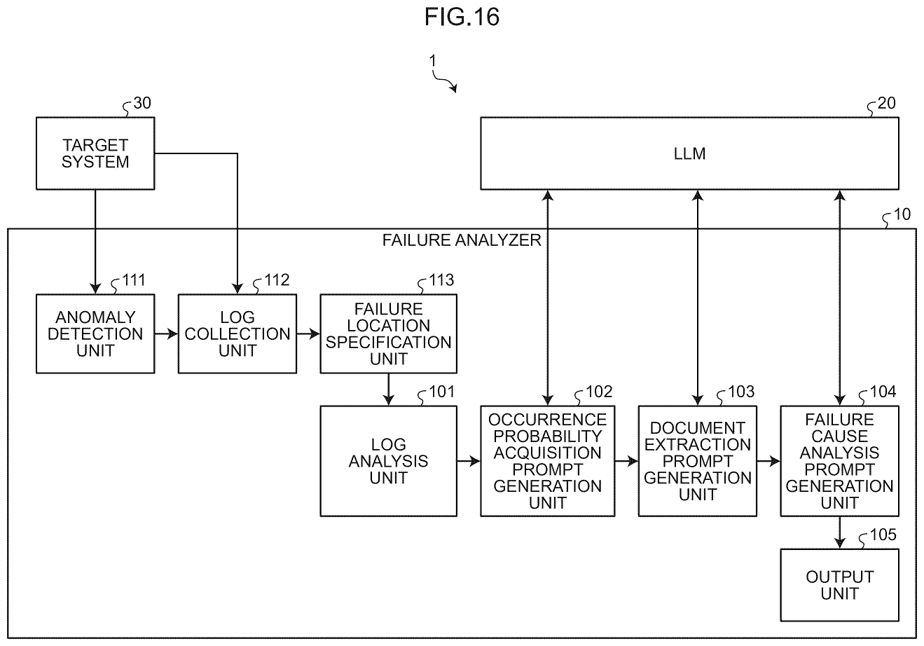

FIG. 16 is a block diagram of an estimation system according to a fourth embodiment. The failure analyzer 10 according to the present embodiment detects occurrence of a failure in a target system 30, automatically specifies a failure location, and executes failure cause analysis on the basis of the specified failure location. As illustrated in FIG. 16, the failure analyzer 10 according to the present embodiment includes an anomaly detection unit 111, a log collection unit 112, and a failure location specification unit 113 in addition to each unit in FIG. 1. In the following description, description of operation of each unit similar to that of the first embodiment will be omitted.

The anomaly detection unit 111 monitors the operation of the target system 30. Then, the anomaly detection unit 111 detects the occurrence of a failure in the target system 30. In a case where the occurrence of the failure is detected, the anomaly detection unit 111 notifies the log collection unit 112 of the content of the failure in which the occurrence of the failure has occurred.

The log collection unit 112 acquires the notification of the occurrence of the failure in the target system 30 and the content of the generated failure from the anomaly detection unit 111. Then, the log collection unit 112 collects a log corresponding to the generated failure from the target system 30. Thereafter, the log collection unit 112 outputs the collected log and the content of the occurred failure to the failure location specification unit 113.

The failure location specification unit 113 acquires the log of the target system 30 collected by the log collection unit 112 and the content of the failure that has occurred in the target system 30. Next, the failure location specification unit 113 specifies a failure location in the target system 30 from the acquired log on the basis of the content of the generated failure. Thereafter, the failure location specification unit 113 outputs the log of the target system 30, the content of the generated failure, and information on the specified failure location to the log analysis unit 101.

The log analysis unit 101 receives an input of the log of the target system 30, the content of the generated failure, and information of the specified failure location from the failure location specification unit 113. Then, the log analysis unit 101 analyzes the acquired log. Each of the occurrence probability acquisition prompt generation unit 102, the document extraction prompt generation unit 103, and the failure cause analysis prompt generation unit 104 generates a prompt on the basis of the analysis result of the log and performs failure cause analysis using the LLM 20.

As described above, the estimation system according to the present embodiment enables automation from anomaly detection to failure cause analysis.

### (e) Fifth Embodiment

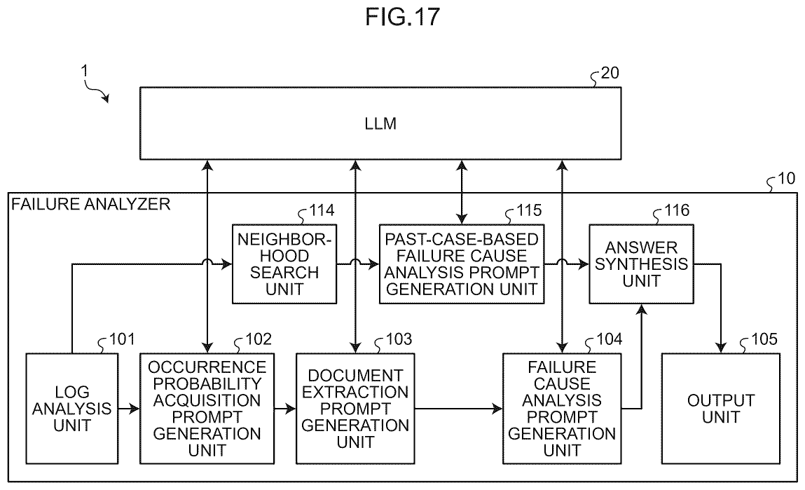

FIG. 17 is a block diagram of an estimation system according to a fifth embodiment. The failure analyzer 10 according to the present embodiment can execute analysis based on past cases in addition to the failure cause analysis using the LLM 20 described in the first embodiment. As illustrated in FIG. 17, the failure analyzer 10 according to the present embodiment includes a neighborhood search unit 114, a past-case-based failure cause analysis prompt generation unit 115, and an answer synthesis unit 116 in addition to each unit in FIG. 1. In the following description, description of operation of each unit similar to that of the first embodiment will be omitted.

The neighborhood search unit 114 has a document summarizing failure cases that have occurred in the past. The neighborhood search unit 114 receives an input of a query describing a failure content and an analysis result of a log from the log analysis unit 101. Then, the neighborhood search unit 114 performs a neighborhood search based on the query describing the failure content and the analysis results of the log with respect to the document summarizing the failure cases occurring in the past, and extracts a related document. Thereafter, the neighborhood search unit 114 outputs analysis results of the extracted related document, the query describing the failure content, and the log to the past-case-based failure cause analysis prompt generation unit 115.

The past-case-based failure cause analysis prompt generation unit 115 receives the input of the extracted related document, the query describing the failure content, and the analysis result of the log from the neighborhood search unit 114. Then, the past-case-based failure cause analysis prompt generation unit 115 generates a past-case-based failure cause analysis prompt that instructs generation of a list of failure causes of the occurred failure from the related document. For example, the past-case-based failure cause analysis prompt generation unit 115 can generate the past-case-based failure cause analysis prompt by adding a failure content or an analysis result of a log to a predetermined format.

Then, the past-case-based failure cause analysis prompt generation unit 115 inputs the generated past-case-based failure cause analysis prompt and related document to the LLM 20. Thereafter, the past-case-based failure cause analysis prompt generation unit 115 acquires a list of past-case-based failure causes from the LLM 20. Then, the past-case-based failure cause analysis prompt generation unit 115 outputs a list of past-case-based failure causes to the answer synthesis unit 116.

Here, the past-case-based failure cause analysis prompt generation unit 115 corresponds to an example of a “fourth inference execution unit”. Then, the past-case-based failure cause analysis prompt generation unit 115 causes the LLM 20 to infer the failure cause on the basis of the past case.

The failure cause analysis prompt generation unit 104 outputs a list of failure causes acquired from the LLM 20 to the answer synthesis unit 116 by using the occurrence probability acquisition prompt generation unit 102, the document extraction prompt generation unit 103, and the prompt generated by itself.

The answer synthesis unit 116 receives an input of a list of past-case-based failure causes from the past-case-based failure cause analysis prompt generation unit 115. In addition, the answer synthesis unit 116 receives, from the failure cause analysis prompt generation unit 104, an input of a list of failure causes based on a technical document generated by using the prompts generated by the document extraction prompt generation unit 103 and the failure cause analysis prompt generation unit 104. Then, the answer synthesis unit 116 synthesizes a list of failure causes on the basis of past cases and a list of failure causes on the basis of technical documents. Then, the answer synthesis unit 116 outputs a list of the synthesized failure causes to the output unit 105.

The output unit 105 receives an input of a list of failure causes synthesized by the answer synthesis unit 116. Then, the output unit 105 displays a list of failure causes on a monitor (not illustrated) or the like and provides the list to the user. In this manner, the output unit 105 outputs the inference result inferred by the LLM 20 by the failure cause analysis prompt generation unit 104 as the second inference execution unit and the inference result inferred by the LLM 20 by the past-case-based failure cause analysis prompt generation unit 115 as the fourth inference execution unit together.

As described above, the estimation system according to the present embodiment can provide both the result of the failure cause analysis based on the past case and the result of the failure cause analysis based on the technical document. In a case where there is a similar case in the past, the failure cause analysis based on the past case may have higher identification accuracy of the failure cause. Therefore, by adding the result of the failure cause analysis based on the past case, it is possible to further improve the identification accuracy of the failure cause.

### (f) Sixth Embodiment

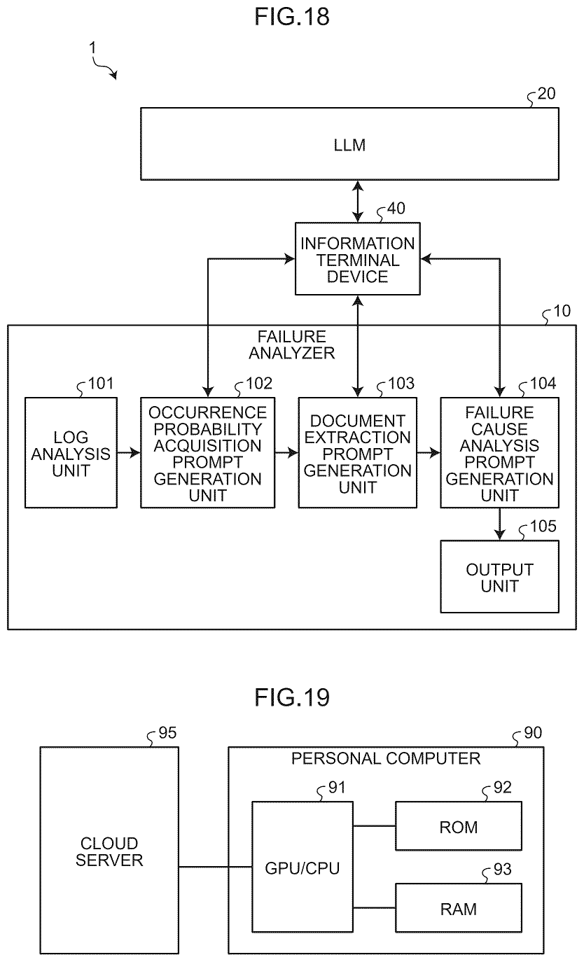

FIG. 18 is a block diagram of an estimation system according to a sixth embodiment. The failure analyzer 10 according to the present embodiment exchanges information with the LLM 20 via an information terminal device 40. In the following description, description of operation of each unit similar to that of the first embodiment will be omitted.

The occurrence probability acquisition prompt generation unit 102 transmits the generated occurrence probability acquisition prompt to the information terminal device 40. The user uses the information terminal device 40 to input the occurrence probability acquisition prompt transmitted from the occurrence probability acquisition prompt generation unit 102 to the LLM 20. Thereafter, the user acquires the information of the occurrence probability of each failure classification output from the LLM 20 using the information terminal device 40, and transmits the information of the occurrence probability of each failure classification to the occurrence probability acquisition prompt generation unit 102.

The document extraction prompt generation unit 103 transmits the generated document extraction prompt to the information terminal device 40. The user uses the information terminal device 40 to input the document extraction prompt transmitted from the document extraction prompt generation unit 103 to the LLM 20. Thereafter, the user acquires the document chunk related to the generated failure output from the LLM 20 using the information terminal device 40, and transmits the document chunk related to the generated failure to the document extraction prompt generation unit 103.

The failure cause analysis prompt generation unit 104 transmits the generated failure cause analysis prompt to the information terminal device 40. The user uses the information terminal device 40 to input the failure cause analysis prompt transmitted from the failure cause analysis prompt generation unit 104 to the LLM 20. Thereafter, the user uses the information terminal device 40 to acquire the list of failure causes of the occurred failure output from the LLM 20, and transmits the list of failure causes of the occurred failure to the occurrence probability acquisition prompt generation unit 102.

Some generated AI may be difficult to use in a form incorporated into a program via an application programming interface (API). In this case, information is transmitted and received using a user interface (UI) on the Web. The estimation system according to the present embodiment can improve the identification accuracy of the failure cause by analyzing the failure cause using such generated AI.

### Hardware Configuration

FIG. 19 is a diagram illustrating an example of a hardware configuration of the estimation system. For example, the estimation system 1 can be implemented by a personal computer 90 and a cloud server 95. The personal computer 90 and the cloud server 95 are connected by a network and can communicate with each other.

The cloud server 95 provides an execution environment for the LLM 20. However, the LLM 20 may be executed in an on-premises environment.

The personal computer 90 implements the function of the failure analyzer 10. The personal computer 90 includes a graphics processing unit (GPU)/central processing unit (CPU) 91, a read only memory (ROM) 92, and a random access memory (RAM) 93. The GPU/CPU 91, the ROM 92, and the RAM 93 are connected via a network.

The ROM 92 stores various programs executed by the GPU/CPU 91. The ROM 92 is used as a temporary memory area of a computer program executed by the GPU/CPU 91.

The GPU/CPU 91 may include either a GPU or a CPU, or may include both. The GPU/CPU 91 executes various programs stored in the ROM 92 using the RAM 93. As a result, the GPU/CPU 91 implements the functions of the failure analyzer 10 according to each embodiment. For example, in the case of the failure analyzer 10 according to the first embodiment, the GPU/CPU 91 implements the functions of the log analysis unit 101, the occurrence probability acquisition prompt generation unit 102, the document extraction prompt generation unit 103, the failure cause analysis prompt generation unit 104, and the output unit 105.

In one aspect, the present invention can improve identification accuracy of a failure cause.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An estimation system comprising:
a memory having a machine learning model and;
a processor coupled to the memory and configured to:
analyze a log related to a failure to determine a failure classification of a failure content;
cause the machine learning model to extract, from a predetermined technical document, a corresponding sentence corresponding to the determined failure classification;
cause the machine learning model to infer a first failure cause based on the corresponding sentence extracted by the machine learning model; and
output the first failure cause.

2. The estimation system according to claim 1, wherein the processor is further configured to,
generate a sentence extraction prompt for causing the machine learning model to extract the corresponding sentence from the predetermined technical document, input the generated sentence extraction prompt to the machine learning model, and output the corresponding sentence from the machine learning model, and
generate a failure cause analysis prompt for inferring a failure cause based on the corresponding sentence, input the generated failure cause analysis prompt to the machine learning model, and output the first failure cause from the machine learning model.

3. The estimation system according to claim 1, wherein the processor is further configured to:
cause the machine learning model to infer an occurrence probability for each of the failure classifications, wherein
cause the machine learning model to extract the corresponding sentence corresponding to the failure classification the occurrence probability of which is equal to or greater than a threshold.

4. The estimation system according to claim 1, wherein the processor is further configured to, determine the failure classification using a failure analysis logic tree indicating a failure classification corresponding to the failure content.

5. The estimation system according to claim 4, wherein the processor is further configured to, determine the failure classification using any one of the failure analysis logic tree automatically generated by artificial intelligence (AI), the failure analysis logic tree generated based on experience of an expert, or the failure analysis logic tree generated by modifying the logic tree automatically generated by the AI by an expert.

6. The estimation system according to claim 1, wherein the processor is further configured to, cause the machine learning model to extract a sentence related to the failure classification as the corresponding sentence using the technical document including at least a specification of a system in which the failure has occurred.

7. The estimation system according to claim 1, wherein the processor is further configured to, cause the machine learning model to infer a plurality of items as the first failure cause and output a list of items of the first failure cause from the machine learning model.

8. The estimation system according to claim 1, wherein the processor is further configured to, cause the machine learning model to clearly indicate a basis for inferring the first failure cause.

9. The estimation system according to claim 1, wherein the processor is further configured to,
cause the machine learning model to infer a second failure cause based on a past case, wherein
output the first failure cause inferred based on the corresponding sentence by the machine learning model and second failure cause inferred based on a past case by the machine learning model together.

10. An information processing apparatus comprising:
memory and;
a processor coupled to the memory and configured to:
analyze a log related to a failure to determine a failure classification of a failure content;
cause a machine learning model to extract, from a predetermined technical document, a corresponding sentence corresponding to the determined failure classification;
cause the machine learning model to infer a failure cause based on the corresponding sentence extracted by the machine learning model; and
output the failure cause.

11. An estimation method comprising:
analyzing a log related to a failure to determine a failure classification of a failure content;
causing the machine learning model to extract, from a predetermined technical document, a corresponding sentence corresponding to the determined failure classification;
causing the machine learning model to infer a failure cause based on the corresponding sentence extracted by the machine learning model; and
outputting the failure cause, by processor.
